(19) United States
(12) Patent Application Publication
(10) Pub. No.: US 2026/0179353 A1
(43) Pub. Date: Jun. 25, 2026

(54) METHOD, APPARATUS, DEVICE AND STORAGE MEDIUM FOR FEATURE DETERMINATION

(71) Applicants: Beijing Youzhuju Network Technology Co., Ltd., Beijing (CN); Lemon Inc., Grand Cayman (KY)

(72) Inventors: Chuofan MA, Beijing (CN); Yi JIANG, Beijing (CN); Zehuan YUAN, Beijing (CN); Bingyue PENG, Los Angeles, CA (US)

(21) Appl. No.: 19/292,830

(22) Filed: Aug. 6, 2025

(30) Foreign Application Priority Data
Dec. 23, 2024 (CN) 202411908045.9

(51) Int. Cl. G06V 10/46; G06T 11/00; G06V 10/75; G06V 10/774; G06V 10/776; G06V 20/62

(52) U.S. Cl. CPC G06V 10/46; G06T 11/00; G06V 10/75; G06V 10/774; G06V 10/776; G06V 20/62

(57) ABSTRACT

Embodiments in the disclosure provide a method, apparatus, device, storage medium, and program product for feature determination. The method includes: determining, using a visual encoder, a visual feature representation of an image, the visual feature representation having a first dimension; dividing the visual feature representation into a plurality of sub-feature representations by dimension; for each of the plurality of sub-feature representations, determining, from a codebook of a plurality of codebooks that corresponds to the sub-feature representation, a quantized feature representation that matches the sub-feature representation, each codebook including a plurality of quantized feature representations; and determining a quantized visual feature representation of the image by concatenating a plurality of quantized feature representations respectively corresponding to the plurality of sub-feature representations, the quantized visual feature representation having the first dimension.

### CROSS REFERENCE

This application claims the benefit of Chinese Patent Application No. 202411908045.9 filed on Dec. 23, 2024, entitled “Method, Apparatus, Device and Storage Medium for Feature Determination”, the entire content of which is incorporated herein by reference.

### TECHNICAL FIELD

Example embodiments in the disclosure generally relate to the field of computer technologies, and in particular, to a method, apparatus, device, and computer-readable storage medium for feature determination.

### BACKGROUND

In recent years, with the rapid growth of multimodal language models, autoregressive modeling has extended its advantages from the linguistic domain to the visual domain. For visual understanding, multimodal language models demonstrate superior performance in tasks such as image captioning and visual question answering. In the field of visual generation, autoregressive methods have also shown scalability, with a trend to catching up with diffusion models in terms of generation quality. How to unify visual understanding and visual generation within a single multimodal language model framework has become an issue of interest.

### SUMMARY

In a first aspect in the disclosure, a method for feature determination is provided. The method includes: determining, using a visual encoder, a visual feature representation of an image, the visual feature representation having a first dimension; dividing the visual feature representation into a plurality of sub-feature representations by dimension; for each of the plurality of sub-feature representations, determining, from a codebook of a plurality of codebooks that corresponds to the sub-feature representation, a quantized feature representation that matches the sub-feature representation, each codebook including a plurality of quantized feature representations; and determining a quantized visual feature representation of the image by concatenating a plurality of quantized feature representations respectively corresponding to the plurality of sub-feature representations, the quantized visual feature representation having the first dimension.

In a second aspect in the disclosure, an apparatus for feature determination is provided. The apparatus includes: a visual feature representation determining module configured to determine, using a visual encoder, a visual feature representation of an image, the visual feature representation having a first dimension; a sub-feature representation dividing module configured to divide the visual feature representation into a plurality of sub-feature representations by dimension; a quantized feature representation determining module configured to, for each of the plurality of sub-feature representations, determine, from a codebook of a plurality of codebooks that corresponds to the sub-feature representation, a quantized feature representation that matches the sub-feature representation, each codebook including a plurality of quantized feature representations; and a quantized visual feature representation determining module configured to determine a quantized visual feature representation of the image by concatenating a plurality of quantized feature representations respectively corresponding to the plurality of sub-feature representations, the quantized visual feature representation having the first dimension.

In a third aspect in the disclosure, an electronic device is provided. The device includes at least one processor; and at least one memory, the at least one memory is coupled to the at least one processor and stores instructions executable by the at least one processor, the instructions, when executed by the at least one processor, causes the electronic device to perform the method of the first aspect.

In a fourth aspect in the disclosure, a computer-readable storage medium is provided. The medium has a computer program stored thereon, the computer program, when executed by a processor, performs the method of the first aspect.

In a fifth aspect in the disclosure, a computer program product is provided. The computer program product includes a computer program, the computer program, when executed by a processor, performs the method of the first aspect.

It would be appreciated that the content described in this section is neither intended to identify key or essential features of the embodiments in the disclosure, nor is it intended to limit the scope of the disclosure. Other features in the disclosure will be readily envisaged through the following description.

### BRIEF DESCRIPTION OF THE DRAWINGS

The foregoing and other features, advantages, and aspects of the embodiments in the disclosure become more apparent with reference to the following detailed description and in conjunction with the drawings. In the drawings, the same or similar reference numerals denote the same or similar elements.

FIG. 1 is a schematic diagram of an example environment in which the embodiments in the disclosure may be implemented;

FIG. 2 illustrates a process of determining a quantized visual feature representation according to some embodiments in the disclosure;

FIG. 3A illustrates an architectural diagram of a first multihead attention module according to some embodiments in the disclosure;

FIG. 3B illustrates an architectural diagram of a second multihead attention module according to some embodiments in the disclosure;

FIG. 4 illustrates a training process of a visual encoder, a visual decoder, and a plurality of codebooks according to some embodiments in the disclosure;

FIG. 5 illustrates a schematic diagram of performance for visual question answering according to some embodiments in the disclosure;

FIG. 6 illustrates a flowchart of a method for feature determination according to some embodiments in the disclosure;

FIG. 7 illustrates an apparatus for feature determination according to some embodiments in the disclosure; and

FIG. 8 illustrates a block diagram of an electronic device in which one or more embodiments in the disclosure may be implemented.

### DETAILED DESCRIPTION

The embodiments in the disclosure are described in more detail below with reference to the drawings. Although some embodiments in the disclosure are shown in the drawings, it would be appreciated that the disclosure may be implemented in various forms and should not be construed as limited to the embodiments set forth herein. Instead, these embodiments are provided for a more thorough and complete understanding of the disclosure. It would be appreciated that the drawings and embodiments in the disclosure are only for illustrative purposes and are not intended to limit the scope of protection of the disclosure.

In the description of the embodiments in the disclosure, the term “include/comprise” and similar terms thereof should be construed as open-ended inclusions, that is, “include/comprise but not limited to”. The term “based on” should be construed as “at least partially based on”. The term “one embodiment” or “the embodiment” should be construed as “at least one embodiment”. The term “some embodiments” should be construed as “at least some embodiments”. Other explicit and implicit definitions may be included below.

It would be appreciated that the data involved in the technical solution (including but not limited to the data itself, acquisition or use of the data) should comply with requirements of corresponding laws, regulations, and related provisions.

It would be appreciated that before the use of the technical solution disclosed in the embodiments in the disclosure, the user shall be informed of the type, range of use, use scenarios, etc., of personal information involved in the disclosure and the authorization of the user shall be obtained in an appropriate manner in accordance with relevant laws and regulations.

For example, in response to reception of an active request from a user, prompt information is sent to the user to clearly inform the user that the requested operation will require access to and use of the user's personal information, so that the user may independently choose, based on the prompt information, whether to provide the personal information to software or hardware, such as an electronic device, an application, a server, or a storage medium, that performs the operations of the technical solution in the disclosure.

As an optional but non-limiting embodiment, in response to the reception of the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It would be appreciated that the above process of notifying the user and obtaining the authorization of the user is only illustrative and does not constitute a limitation on the embodiments in the disclosure, and other manners that satisfy the relevant laws and regulations may also be applied in the embodiments in the disclosure.

As used herein, the term “model” may learn an association between respective inputs and outputs from training data, so that once the training is complete, a corresponding output may be generated for a given input. The generation of the model may be based on machine learning techniques. Deep learning is a machine learning algorithm that uses multiple layers of processors to process inputs and provide corresponding outputs. A neural network model is an example of a model based on deep learning. Herein, a “model” may also be referred to as a “machine learning model”, a “learning model”, a “machine learning network”, or a “learning network”, which terms are used interchangeably herein.

A “neural network” is a machine learning network based on deep learning. A neural network may process an input and provide a corresponding output, and typically includes an input layer and an output layer, as well as one or more hidden layers between the input layer and the output layer. Neural networks used in deep learning applications typically include many hidden layers, thereby increasing the depth of the network. The layers of the neural network are connected in sequence, so that the output of a previous layer is provided as the input of a next layer, where the input layer receives the input of the neural network, and the output of the output layer serves as the final output of the neural network. Each layer of the neural network includes one or more nodes (also referred to as processing nodes or neurons), each of which processes the input from the previous layer.

Generally speaking, machine learning may roughly include three stages, namely, a training stage, a testing stage, and an application stage (also referred to as an inference stage). In the training stage, a given model may be trained using a large amount of training data, and a parameter value may be updated through continuous iteration until the model may obtain consistent inference that meets an expected objective from the training data. Through training, it may be considered that the model may learn an association (also referred to as a mapping from the input to the output) from an input to an output from the training data. The parameter value of the trained model is determined. In the testing stage, a test input is applied to the trained model to test whether the model may provide a correct output, thereby determining the performance of the model. The testing stage may sometimes be incorporated into the training stage. In the application or inference stage, the trained model may be used to process an actual model input based on the parameter value obtained through training, to determine a corresponding model output.

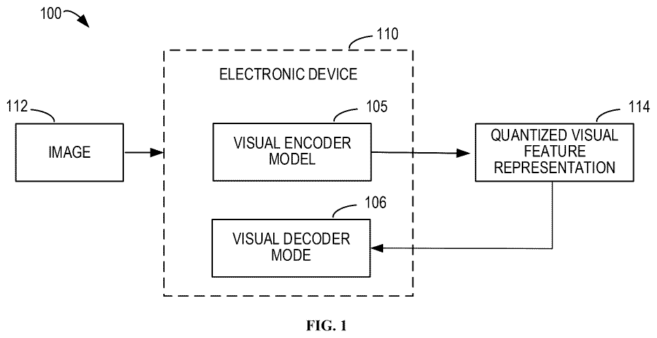

FIG. 1 is a schematic diagram of an example environment 100 in which the embodiments in the disclosure may be implemented. In the environment 100, an electronic device 110 applies a visual encoder model 105 to perform feature extraction on visual data. The visual encoder model 105 is configured to generate a quantized visual feature representation 114 based on an image 112. In some examples, the quantized visual feature representation 114 is a discrete feature representation.

In some embodiments, the visual encoder model 105 may compress the image 112 into the quantized visual feature representation 114 in a low-dimensional latent space, to implement compression of the image 112, thereby reducing the data volume of the image 112.

In some embodiments, a reconstructed image for the image 112 may be generated from the quantized visual feature representation 114 using a visual decoder model 106.

It should be noted that the input of the visual decoder model 106 is not limited to the quantized visual feature representation 114 output from the visual encoder model 105, and the visual decoder model 106 may generate an image based on any feature representation.

In the environment 100, the electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a gaming device, or any combination thereof, including the accessories and peripherals of these devices, or any combination thereof. In some embodiments, the electronic device 110 may also support any type of user-specific interface (such as a “wearable” circuit, etc.). The feature determination model 105, for example, may be implemented in various types of computing systems/servers that may provide computing power, including but not limited to mainframes, edge computing nodes, computing devices in cloud environments, and the like.

It would be appreciated that the structures and functions of the elements in the environment 100 are described for illustrative purposes only, without suggesting any limitation to the scope of the disclosure.

As mentioned above, the development of multimodal language models has triggered interest in unifying visual generation and visual understanding within the single multimodal language model framework. One related work adopts a contrastive language-image pretraining (CLIP) model as a visual tokenizer, which has been demonstrated to be beneficial for visual understanding tasks. However, due to the continuity of CLIP tokens, it is challenging to incorporate visual generation into the autoregressive framework. Therefore, these methods usually rely on external diffusion models to synthesize images. To address this issue, another line of research has chosen a vector-quantized variational autoencoder (VQVAE) tokenizer, which converts an image into discrete codes, similar to the language tokenization process. This enables unified modeling of visual and language sequences with the same next-token prediction loss. However, compared with understanding-oriented multimodal language models, these methods exhibit poor visual understanding capabilities because vector quantization (VQ) tokens are not naturally aligned with the language feature space.

In the field of visual generation, image tokenization plays an important role in encoding raw pixels into compact latent features for generative modeling. Among various tokenizers, vector quantization tokenizers are more widely used due to their discrete latent space and compatibility with autoregressive and masked generation models. Some related work has proposed discretizing feature vectors by mapping continuous tokens to nearest neighbors in a learnable codebook.

In the field of visual understanding, the success of language models has catalyzed the development of multimodal language models, which have demonstrated superior capabilities in visual language tasks that require advanced understanding and reasoning. As a key component of multimodal language models, the selection of an effective visual tokenizer has been the subject of extensive research. A common choice of visual tokenizer is a pre-trained CLIP model, which is aligned with language during the pre-training stage. Alternatively, a self-supervised learning model may be used as a visual tokenizer. However, these tokenizers mainly encode images into continuous tokens, which poses challenges to the unified modeling of visual and text tokens. To meet these challenges, some related work has explored discretizing CLIP tokens or adopting a VQVAE encoder for tokenization in multimodal language models. However, these solutions may impair the performance of visual understanding tasks.

To address the above problem that the tokenizer cannot extract feature representations effectively, in the embodiments in the disclosure, a solution for feature determination is proposed. Specifically, a visual feature representation of an image is determined using a visual encoder, the visual feature representation having a first dimension; the visual feature representation is divided into a plurality of sub-feature representations by dimension; for each of the plurality of sub-feature representations, a quantized feature representation that matches the sub-feature representation is determined from a codebook of a plurality of codebooks that corresponds to the sub-feature representation, each codebook including a plurality of quantized feature representations; and a quantized visual feature representation of the image is determined by concatenating a plurality of quantized feature representations respectively corresponding to the plurality of sub-feature representations, the quantized visual feature representation having the first dimension.

According to the solution in the disclosure, each of the plurality of codebooks may be used to determine the quantized feature representation corresponding to the sub-feature representation of the image, thereby avoiding the optimization problem associated with a large codebook while the size of a single codebook is kept unchanged. In this way, the dimension of the quantized visual feature representation of the image scales proportionally with the number of codebooks, thereby improving the representational capability of the quantized visual feature representation.

Some example embodiments in the disclosure are described below with continued reference to the drawings.

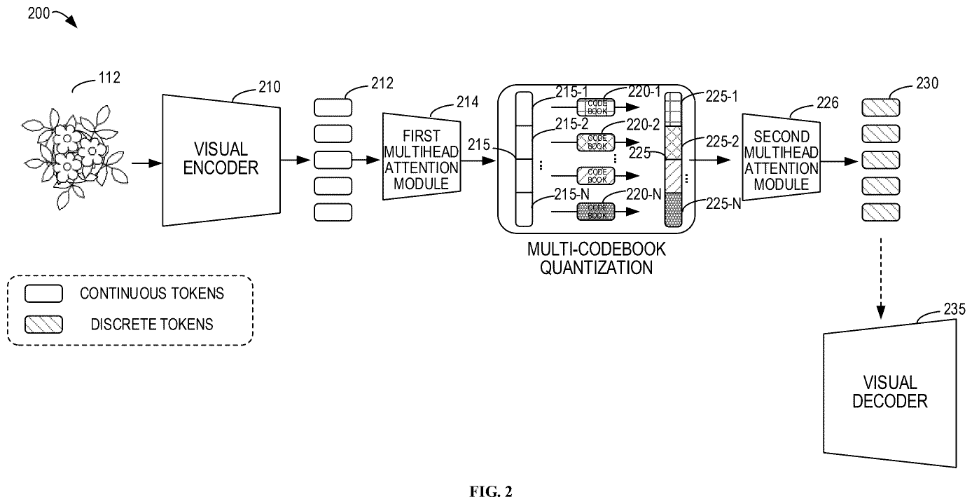

FIG. 2 illustrates a process 200 of determining the quantized visual feature representation 114 according to some embodiments in the disclosure. As shown in FIG. 2, a visual feature representation 215 of the image 112 may be determined using a visual encoder 210. The visual feature representation 215 may have a first dimension (for example, 64 dimensions). In some examples, the visual feature representation 215 may be represented by continuous tokens.

After the visual feature representation 215 is determined, the visual feature representation 215 may be divided into a plurality of sub-feature representations 215-1 to 215-n by dimension.

In some embodiments, the visual feature representation 215 may be evenly divided in terms of the dimension to obtain the plurality of sub-feature representations 215-1 to 215-n. In some examples, a latent vector f∈ [symbol] (also referred to as the visual feature representation 215) may be evenly divided into n blocks {f₁, f₂, . . . , fₙ}, where

$${f}_{i} ∈ {ℝ}^{\frac{d}{n}} .$$

For example, the dimension corresponding to the visual feature representation 215 is 64-dimensional, and the visual feature representation 215 may be divided into four 16-dimensional sub-feature representations.

Alternatively, or in addition, the visual feature representation 215 may be unevenly divided in terms of the dimension to obtain the plurality of sub-feature representations 215-1 to 215-n. For example, the 64-dimensional visual feature representation 215 is divided into four sub-feature representations with dimensions of 16-dimensional, 18-dimensional, 14-dimensional, and 16-dimensional, respectively. A specific dimension division manner may depend on specific configuration requirements, which is not limited in the embodiments in the disclosure.

After the plurality of sub-feature representations 215-1 to 215-n are obtained through division, for each of the plurality of sub-feature representations, a quantized feature representation that matches the sub-feature representation is determined from a codebook of the plurality of codebooks 220-1 to 220-n (collectively referred to as the plurality of codebooks 220 for ease of description) that corresponds to the sub-feature representation. Each codebook may include a plurality of quantized feature representations. The quantized feature representations in the plurality of codebooks 220 are learnable, and may be determined during the training process of the visual encoder 210. For example, to determine the quantized feature representation that matches the sub-feature representation 215-1, first, a quantized feature representation 225-1 that matches the sub-feature representation 215-1 is determined from the codebook (for example, the codebook 220-1) that corresponds to the sub-feature representation 215-1 in the plurality of codebooks. In another example, to determine the quantized feature representation that matches the sub-feature representation 215-2, a quantized feature representation 225-2 that matches the sub-feature representation 215-2 may be determined from the codebook (for example, the codebook 220-2) that corresponds to the sub-feature representation 215-2 in the plurality of codebooks, until the quantized feature representation 225-n corresponding to the sub-feature representation 215-n is determined.

In some embodiments, each of the plurality of codebooks 220 corresponds to a respective dimension interval divided from the first dimension. For example, the first dimension is 64-dimensional, and there are four codebooks in total. The codebook 220-1 corresponds to the first to sixteenth dimensions in the first dimension, the codebook 220-2 corresponds to the seventeenth to thirty-second dimensions in the first dimension, and so on. In some embodiments, the codebook corresponding to the sub-feature representation may be determined based on the dimension interval of the sub-feature representation, and the quantized feature representation that matches the sub-feature representation may be determined from the corresponding codebook. In an example, the dimension interval of the sub-feature representation 215-1 is the first to sixteenth dimensions, and the codebook 220-1 corresponding to the sub-feature representation 215-1 may be determined. Then, the quantized feature representation 225-1 that matches the sub-feature representation 215-1 may be determined from the codebook 220-1.

After the quantized feature representations 225-1 to 225-n respectively corresponding to the plurality of sub-feature representations 215-1 to 215-n are determined, the plurality of quantized feature representations may be concatenated to determine the quantized visual feature representation 225 of the image 205. The quantized visual feature representation 225 has the first dimension. In some examples, the quantized visual feature representation 225 may be represented by discrete tokens. Concatenating the plurality of quantized feature representations may be as follows:

$$\hat{f} = Concat ( Q ( {Z}_{1} , {f}_{1} ) , Q ( {Z}_{2} , {f}_{2} ) , … , Q ( {Z}_{n} , {f}_{n} ) ) \qquad ( 1 )$$

where \hat{f} represents a discrete latent vector (also referred to as the quantized visual feature representation 225), Q represents a code index query operation, Zᵢ represents the ith codebook, and Q(Zᵢ, fᵢ) represents the ith quantized feature representation.

In some embodiments, the plurality of quantized feature representations 225-1 to 225-n may be concatenated in the corresponding dimension interval to obtain the quantized visual feature representation 225. In an example, the dimension intervals respectively corresponding to the quantized feature representations 225-1 to 225-4 are the first to sixteenth dimensions, the seventeenth to thirty-second dimensions, the thirty-third to forty-eighth dimensions, and the forty-ninth to sixty-fourth dimensions. The quantized feature representations 225-1 to 225-4 are concatenated in the corresponding dimension interval to obtain the 64-dimensional quantized visual feature representation 225. In this way, the dimension of the quantized visual feature representation increases with the number of codebooks, thereby improving the representational capability of the quantized visual feature representation.

In some embodiments, an intermediate visual feature representation 220 of the image 112 may be extracted using the visual encoder 210. The dimension corresponding to the intermediate visual feature representation 212 is a second dimension, and the second dimension (for example, 768-dimensional) is greater than the first dimension (for example, 64-dimensional). Then, a first multihead attention module 214 (also referred to as a dimensionality compression module) may be used to perform a dimensionality reduction operation on the intermediate visual feature representation 212 to obtain the visual feature representation 215 having the first dimension.

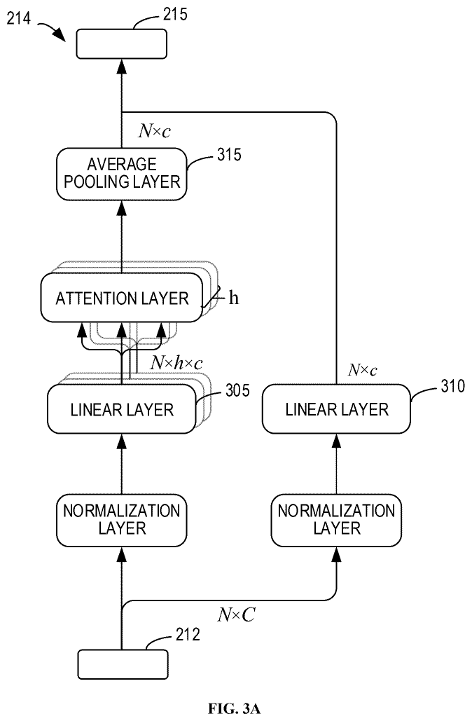

The dimensionality reduction operation performed on the intermediate visual feature representation 212 is described below with reference to FIG. 3A. FIG. 3A is an architectural diagram of the first multihead attention module 214 according to some embodiments in the disclosure. As shown in FIG. 3A, the dimension of the intermediate visual feature representation 212 input to the first multihead attention module 214 is N×C (as an example of the second dimension), and the dimension of the feature representation output from the linear layer 305 is N×h×c, where C=h×c. The linear layer 310 and the average pooling layer 315 may compress the dimension of the intermediate visual feature representation from the second dimension to the first dimension (for example, N×c) to obtain the visual feature representation 215. In this way, the relative density of the visual feature representation may be increased by compressing the intermediate visual feature representation, thereby reducing the quantization error. The compressed visual feature representation 215 having the first dimension may continue to be quantized through the plurality of codebooks 220 to obtain the quantized visual feature representation 225.

The quantized feature representation 225 may represent the visual feature information of the image with a smaller dimension. In some embodiments, a target image is generated using the visual decoder 235 based on the quantized visual feature representation 225. In some examples, the dimensionality expansion operation may be performed on the quantized visual feature representation 225 to obtain the target quantized feature representation 230, and then the visual decoder 235 may decode the target quantized feature representation 230 to obtain the target image.

In some embodiments, a language model (not shown) may be used to generate visual understanding of the image 112 based on the quantized visual feature representation 225. For example, the language model may generate a description text “flowers and grass” for the image 112 based on the quantized visual feature representation 225.

In some embodiments, the language model may be used to continue writing the quantized visual feature representation 225, and then the visual decoder 235 may generate an image related to the image 112 from the quantized visual feature representation 225 after continuation.

With continued reference to FIG. 2, the visual decoder 235 may be used to generate a reconstructed image from the quantized feature representation. In some embodiments, an intermediate quantized feature representation for image generation may be obtained, the intermediate quantized feature representation having the first dimension. In some examples, the intermediate quantized feature representation may be the quantized visual feature representation 225 of the image 205. Alternatively or in addition, the intermediate quantized feature representation may be a quantized feature representation generated by a content generation model (for example, a language model). In the following, an example in which the intermediate quantized feature representation input to the visual decoder 235 is the quantized visual feature representation 225 of the image 112 is used for description. Before being input to the visual decoder 235, the second multihead attention module 226 (also referred to as a dimensionality expansion module) is first used to perform the dimensionality expansion operation on the intermediate quantized feature representation (that is, the quantized visual feature representation 225) having the first dimension to obtain the target quantized feature representation 230 having the second dimension. The target image may be generated using the visual decoder 235 based on the target quantized feature representation 230.

The dimensionality expansion operation performed on the intermediate quantized feature representation is described below with reference to FIG. 3B. FIG. 3B is an architectural diagram of the second multihead attention module 226 according to some embodiments in the disclosure. As shown in FIG. 3B, the dimension of the intermediate quantized feature representation input to the second multihead attention module 226 is N×c (as an example of the first dimension), and the linear layer 354 and the linear layer 356 expand the dimension of the intermediate quantized feature representation from the first dimension to the second dimension (for example, N×C) to obtain the target quantized feature representation 230. According to the embodiments in the disclosure, the multihead attention mechanism is used to reduce the dimension of the feature representation and then expand the dimension of the feature representation, which may effectively improve the representational capability of the target quantized feature representation.

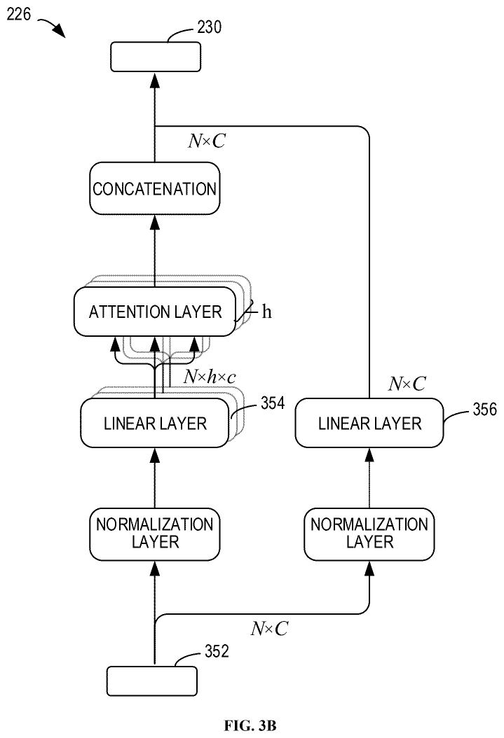

The training process of the visual encoder 210, the visual decoder 235, and the plurality of codebooks 220 is described below with reference to FIG. 4. FIG. 4 illustrates a training process 400 of the visual encoder 210, the visual decoder 235, and the plurality of codebooks 220 according to some embodiments in the disclosure. As shown in FIG. 4, a sample visual feature representation 410 of a sample image 405 may be determined using the visual encoder 210 being trained. A sample quantized visual feature representation 415 corresponding to the sample visual feature representation 410 may be determined based on the plurality of codebooks being trained.

In some embodiments, visual generation and visual understanding usually impose different requirements on a visual tokenizer (for example, the visual encoder 210). For example, visual generation emphasizes lossless compression for accurate reconstruction, while visual understanding prioritizes semantically meaningful and discriminative features. Therefore, an image-text contrastive loss may be used to enhance high-level semantic information in the feature representation. To determine the contrastive loss, a text encoder 420 may be used to determine a first text feature representation 422 of a positive sample text 418 and a second text feature representation of a negative sample text (not shown), respectively, where the positive sample text matches the sample image, and the negative sample text does not match the sample image. For example, the sample image 405 is an oil painting of a rural scenery, the positive sample text 418 may be “an oil painting depicting a rural scenery”, and the negative sample text may be “a sketch depicting a person”. Then, a contrastive loss [symbol] _{contra} 425 may be determined based on a difference between the sample quantized visual feature representation 410 and the first text feature representation 422 and a difference between the sample quantized visual feature representation 410 and the second text feature representation. The value of the contrastive loss 425 is positively correlated with the difference between the sample quantized visual feature representation 410 and the first text feature representation 422, and is negatively correlated with the difference between the sample quantized visual feature representation 410 and the second text feature representation. Next, the visual encoder 210, the visual decoder 235, and the plurality of codebooks 220 are updated based on a first training objective configured to reduce or minimize the contrastive loss. In this way, the visual encoder 210, the visual decoder 235, and the plurality of codebooks 220 are trained based on the reconstruction loss between the image and the text, and the quantized visual feature representation of the image may improve the representation of high-level semantic information for visual understanding.

In some embodiments, the reconstruction loss (for example, a VQVAE-based reconstruction loss) may retain low-level information in the feature representation. To determine the reconstruction loss, the visual decoder 235 may be used to generate a reconstructed image 430 corresponding to the sample image 405 based on the sample quantized visual feature representation 415. A reconstruction loss 435 is determined based on a difference between the sample image 405 and the reconstructed image 430. In some examples, the reconstruction loss 435 (represented by [symbol] ) may include a pixel-level reconstruction loss (represented by [symbol] ), a perceptual loss (represented by [symbol] ), a discriminator loss for enhancing reconstruction fidelity (represented by [symbol] ), an entropy loss for encouraging codebook utilization (represented by [symbol] _{E}), and a vector quantization loss (represented by [symbol] ) that minimizes the distance between the output of the visual encoder and its nearest code entry. The reconstruction loss may be expressed as follows:

$${ℒ}_{r econ} = {ℒ}_{R} + {ℒ}_{VQ} + {λ}_{P} {ℒ}_{P} + {λ}_{G} {ℒ}_{G} + {λ}_{E} {ℒ}_{E} \qquad ( 2 )$$

where λ represents a weighting factor for the corresponding loss term.

After the loss function is constructed, the visual encoder, the visual decoder, and the plurality of codebooks are further updated based on a second training objective configured to reduce or minimize a combination of the contrastive loss and the reconstruction loss. The combination of the contrastive loss and the reconstruction loss may be expressed as follows:

$$ℒ = {ℒ}_{r e c o n} + {λ}_{contra} {ℒ}_{contra} \qquad ( 3 )$$

where [symbol] represents the contrastive loss, and λ_{contra} represents a weighting factor corresponding to the contrastive loss. In an example, λ_{contra} may be set to 1. According to the embodiments in the disclosure, the reconstruction loss may retain low-level information for visual generation. By combining the contrastive loss and the reconstruction loss, the quantized visual feature representation of the image may improve both the representation of high-level semantic information for visual understanding and the representation of information for visual generation, thereby unifying visual understanding and visual generation in a single multimodal language model. It should be noted that, for ease of description, the operation of determining the quantized feature representation using each of the plurality of codebooks and the dimensionality expansion and reduction of the feature representation are not repeatedly described in the process 400, and reference may be made to the process 200 for related description.

In some embodiments, the text encoder 420 may be jointly trained with the visual encoder and the visual decoder. That is, the text encoder 420 may also be jointly updated based on the first training objective or the second training objective. During the training process, the parameters of the text encoder 420 are updated, so that a more accurate text feature representation may be determined.

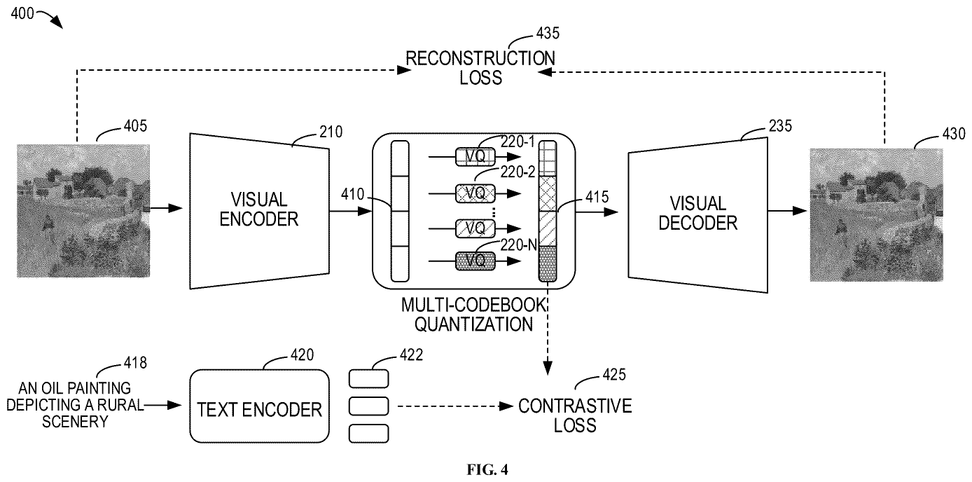

FIG. 5 is a schematic diagram 500 of performance for visual question answering according to some embodiments in the disclosure. As shown in FIG. 5, after experiments, histograms 502, 504, and 506 represent the accuracy of quantized feature representations using the related technologies in a visual question answering task. Histograms 510 and 520 represent the accuracy of quantized feature representations using the embodiments (that is, the plurality of codebooks and the multihead attention mechanism) in the disclosure in the visual question answering task. It may be seen from FIG. 5 that, according to some embodiments in the disclosure, the plurality of codebooks may be used to more accurately extract the quantized visual feature of the image, and the reconstruction loss and the contrastive loss may be constructed based on the quantized visual feature. The text encoder, the visual encoder, and the visual decoder may be jointly trained based on the reconstruction loss and the contrastive loss, and the accuracy of the quantized feature representation extracted after training in the visual question answering task is significantly higher than that of the related technologies. Further, the multihead attention mechanism may be added to perform the dimensionality expansion and reduction operations on the feature representation extracted during the training process, thereby further improving the accuracy of the quantized feature representation in visual question answering tasks. According to the disclosed embodiments, the plurality of codebooks and the multihead attention mechanism may be used to extract a more accurate quantized feature representation for visual understanding, thereby obtaining higher accuracy.

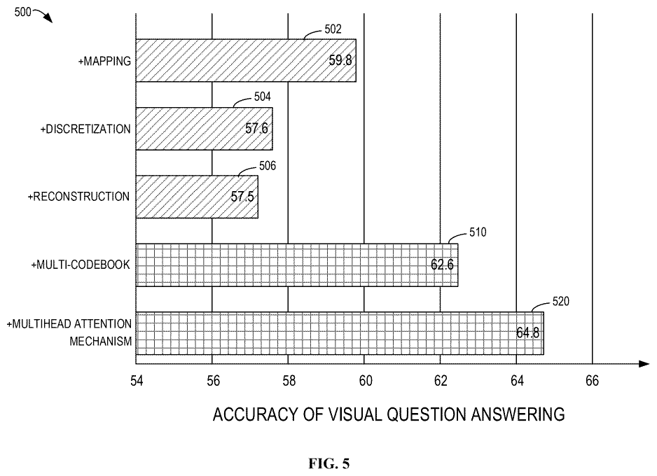

FIG. 6 is a flowchart of a method for feature determination 600 according to some embodiments in the disclosure. The method 600 may be implemented at the electronic device 110 in FIG. 1. The method 600 will be described with reference to the environment 100 in FIG. 1.

At block 610, the electronic device 110 determines, using a visual encoder, a visual feature representation of an image, the visual feature representation having a first dimension.

At block 620, the electronic device 110 divides the visual feature representation into a plurality of sub-feature representations by dimension.

At block 630, the electronic device 110, for each of the plurality of sub-feature representations, determines, from a codebook of a plurality of codebooks that corresponds to the sub-feature representation, a quantized feature representation that matches the sub-feature representation, each codebook including a plurality of quantized feature representations.

At block 640, the electronic device 110 determines a quantized visual feature representation of the image by concatenating a plurality of quantized feature representations respectively corresponding to the plurality of sub-feature representations, the quantized visual feature representation having the first dimension.

In some embodiments, the method 600 further includes: generating, using a visual decoder, a target image based on the quantized visual feature representation.

In some embodiments, the visual encoder, the visual decoder, and the plurality of codebooks are trained by: determining, using the visual encoder being trained, a sample visual feature representation of a sample image; determining a sample quantized visual feature representation corresponding to the sample visual feature representation based on the plurality of codebooks being trained; determining, using a text encoder, a first text feature representation of a positive sample text and a second text feature representation of a negative sample text, respectively, where the positive sample text matches the sample image, and the negative sample text does not match the sample image; determining a contrastive loss based on a difference between the sample quantized visual feature representation and the first text feature representation and a difference between the sample quantized visual feature representation and the second text feature representation; and updating the visual encoder, the visual decoder, and the plurality of codebooks based on a first training objective configured to reduce or minimize the contrastive loss.

In some embodiments, updating the visual encoder, the visual decoder, and the plurality of codebooks further includes: generating, using the visual decoder, a reconstructed image corresponding to the sample image based on the sample quantized visual feature representation; determining a reconstruction loss based on a difference between the sample image and the reconstructed image; and updating the visual encoder, the visual decoder, and the plurality of codebooks further based on a second training objective configured to reduce or minimize a combination of the contrastive loss and the reconstruction loss.

In some embodiments, the text encoder is jointly updated based on the first training objective or the second training objective.

In some embodiments, dividing the visual feature representation into the plurality of sub-feature representations by dimension includes: dividing the visual feature representation evenly by dimension to obtain the plurality of sub-feature representations.

In some embodiments, each of the plurality of codebooks corresponds to a respective dimension interval divided from the first dimension, and determining the quantized feature representation that matches the sub-feature representation includes: determining, based on a dimension interval of the sub-feature representation, the codebook corresponding to the sub-feature representation; and determining, from the corresponding codebook, the quantized feature representation that matches the sub-feature representation.

In some embodiments, determining the quantized visual feature representation includes: concatenating the plurality of quantized feature representations based on the corresponding dimension intervals to obtain the quantized visual feature representation.

In some embodiments, determining the visual feature representation includes: extracting, using the visual encoder, an intermediate visual feature representation of the image, where a dimension corresponding to the intermediate visual feature representation is a second dimension, and the second dimension is greater than the first dimension; and performing, using a first multihead attention module, a dimensionality reduction operation on the intermediate visual feature representation to obtain the visual feature representation having the first dimension.

In some embodiments, the method 600 further includes: obtaining an intermediate quantized feature representation for image generation, the intermediate quantized feature representation having the first dimension; performing, using a second multihead attention module, a dimensionality expansion operation on the intermediate quantized feature representation to obtain a target quantized feature representation, a dimension corresponding to the target quantized feature representation being the second dimension; and generating, using the visual decoder, a target image based on the target quantized feature representation.

In some embodiments, performing the dimensionality reduction operation on the intermediate visual feature representation to obtain the visual feature representation includes: compressing, using a first linear layer and an average pooling layer in the first multihead attention module, the dimension of the intermediate visual feature representation from the second dimension to the first dimension to obtain the visual feature representation.

In some embodiments, performing the dimensionality expansion operation on the intermediate quantized feature representation to obtain the target quantized feature representation includes: expanding, using a second linear layer and a third linear layer in the second multihead attention module, the dimension of the intermediate quantized feature representation from the first dimension to the second dimension to obtain the target quantized feature representation.

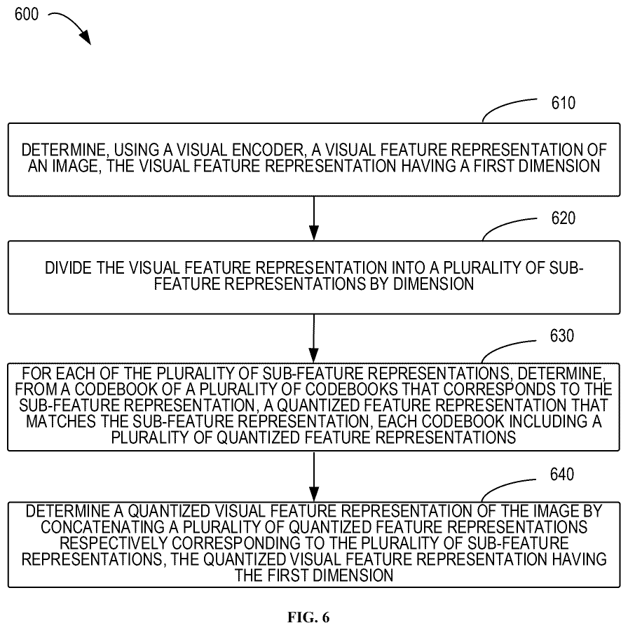

The embodiments in the disclosure further provide a corresponding apparatus for implementing the above method or process. FIG. 7 illustrates an apparatus for feature determination according to some embodiments in the disclosure. The apparatus 700 may be implemented as or included in the electronic device 110. Each module/component in the apparatus 700 may be implemented by hardware, software, firmware, or any combination thereof.

As shown in FIG. 7, the apparatus 700 includes a visual feature representation determining module 710 configured to determine, using a visual encoder, a visual feature representation of an image, the visual feature representation having a first dimension; a sub-feature representation dividing module 720 configured to divide the visual feature representation into a plurality of sub-feature representations by dimension; a quantized feature representation determining module 730 configured to, for each of the plurality of sub-feature representations, determine, from a codebook of a plurality of codebooks that corresponds to the sub-feature representation, a quantized feature representation that matches the sub-feature representation, each codebook including a plurality of quantized feature representations; and a quantized visual feature representation determining module 740 configured to determine a quantized visual feature representation of the image by concatenating a plurality of quantized feature representations respectively corresponding to the plurality of sub-feature representations, the quantized visual feature representation having the first dimension.

In some embodiments, the apparatus 700 further includes a target image generating module configured to generate, using a visual decoder, a target image based on the quantized visual feature representation.

In some embodiments, the apparatus 700 further includes a training module configured to: determine, using the visual encoder being trained, a sample visual feature representation of a sample image; determine a sample quantized visual feature representation corresponding to the sample visual feature representation based on the plurality of codebooks being trained; determine, using a text encoder, a first text feature representation of a positive sample text and a second text feature representation of a negative sample text, respectively, where the positive sample text matches the sample image, and the negative sample text does not match the sample image; determine a contrastive loss based on a difference between the sample quantized visual feature representation and the first text feature representation and a difference between the sample quantized visual feature representation and the second text feature representation; and update the visual encoder, the visual decoder, and the plurality of codebooks based on a first training objective configured to reduce or minimize the contrastive loss.

In some embodiments, the training module is further configured to: generate, using the visual decoder, a reconstructed image corresponding to the sample image based on the sample quantized visual feature representation; determine a reconstruction loss based on a difference between the sample image and the reconstructed image; and update the visual encoder, the visual decoder, and the plurality of codebooks further based on a second training objective configured to reduce or minimize a combination of the contrastive loss and the reconstruction loss.

In some embodiments, the text encoder is jointly updated based on the first training objective or the second training objective.

In some embodiments, the sub-feature representation dividing module 720 is further configured to divide the visual feature representation evenly by dimension to obtain the plurality of sub-feature representations.

In some embodiments, each of the plurality of codebooks corresponds to a respective dimension interval divided from the first dimension. The quantized feature representation determining module 730 is further configured to determine, based on a dimension interval of the sub-feature representation, the codebook corresponding to the sub-feature representation; and determine, from the corresponding codebook, the quantized feature representation that matches the sub-feature representation.

In some embodiments, the quantized visual feature representation determining module 740 is further configured to concatenate the plurality of quantized feature representations based on the corresponding dimension intervals to obtain the quantized visual feature representation.

In some embodiments, the visual feature representation determining module 710 is further configured to: extract, using the visual encoder, an intermediate visual feature representation of the image, where a dimension corresponding to the intermediate visual feature representation is a second dimension, and the second dimension is greater than the first dimension; and perform, using a first multihead attention module, a dimensionality reduction operation on the intermediate visual feature representation to obtain the visual feature representation having the first dimension.

In some embodiments, the apparatus 700 further includes a dimensionality expansion module configured to: obtain an intermediate quantized feature representation for image generation, the intermediate quantized feature representation having the first dimension; perform, using a second multihead attention module, a dimensionality expansion operation on the intermediate quantized feature representation to obtain a target quantized feature representation, a dimension corresponding to the target quantized feature representation being the second dimension; and generate, using the visual decoder, a target image based on the target quantized feature representation.

In some embodiments, the visual feature representation determining module 710 is further configured to compress, using a first linear layer and an average pooling layer in the first multihead attention module, the dimension of the intermediate visual feature representation from the second dimension to the first dimension to obtain the visual feature representation.

In some embodiments, the dimensionality expansion module is further configured to expand, using a second linear layer and a third linear layer in the second multihead attention module, the dimension of the intermediate quantized feature representation from the first dimension to the second dimension to obtain the target quantized feature representation.

The units and/or modules included in the apparatus 700 may be implemented in various ways, including software, hardware, firmware, or any combination thereof. In some embodiments, one or more units and/or modules may be implemented using software and/or firmware, for example machine executable instructions stored on a storage medium. In addition to machine executable instructions or as an alternative, some or all units and/or modules in the apparatus 700 may be implemented at least partially by one or more hardware logic components. As an example, rather than a limitation, example types of hardware logic components that may be used include field programmable gate array (FPGA), application specific integrated circuit (ASIC), application specific standard (ASSP), system on chip (SOC), complex programmable logical device (CPLD), and so on.

It would be appreciated that one or more steps in the above method may be performed by a suitable electronic device or a combination of electronic devices. Such an electronic device or a combination of electronic devices may include, for example, the electronic device 110 in FIG. 1.

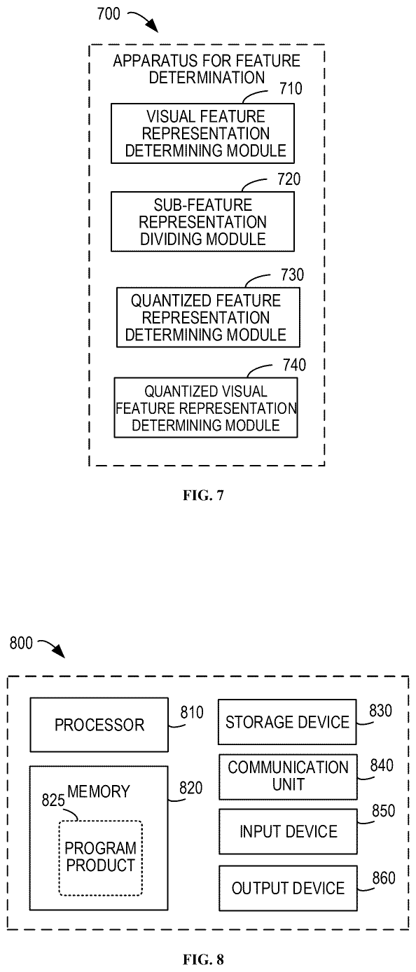

FIG. 8 is a block diagram of an electronic device 800 in which one or more embodiments in the disclosure may be implemented. It would be appreciated that the electronic device 800 shown in FIG. 8 is merely exemplary and should not constitute any limitation on the functionality and scope of the embodiments described herein. The electronic device 800 shown in FIG. 8 may be used to implement the electronic device 110 in FIG. 1 or the apparatus 700 in FIG. 7.

As shown in FIG. 8, the electronic device 800 is in the form of a general-purpose electronic device. The components of the electronic device 800 may include, but are not limited to, one or more processors or processing units 810, a memory 820, a storage device 830, one or more communication units 840, one or more input devices 850, and one or more output devices 860. The processor 810 may be an actual or virtual processor and may perform various processing based on the program stored in the memory 820. In a multi-processor system, a plurality of processors perform computer executable instructions in parallel, to improve the parallel processing capability of the electronic device 800.

The electronic device 800 typically includes a plurality of computer storage medium. Such medium may be any available medium accessible to the electronic device 800, including but not limited to volatile and non-volatile medium, removable and non-removable medium. The memory 820 may be a volatile memory (for example, a register, a cache, a random access memory (RAM)), a non-volatile memory (for example, a read-only memory (ROM), an electrically erasable programmable read-only memory (EEPROM), a flash memory), or any combination thereof. The storage device 830 may be any removable or non-removable medium, and may include a machine-readable medium, such as a flash drive, a disk, or any other medium, which may be used to store information and/or data and may be accessed within the electronic device 800.

The electronic device 800 may further include additional removable/non-removable, volatile/non-volatile memory medium. Although not shown in FIG. 8, a disk drive for reading from or writing into removable and non-volatile disks (such as a “floppy disk”), and an optical disk drive for reading from or writing into removable and non-volatile optical disks may be provided. In these cases, each drive may be connected to a bus (not shown) by one or more data medium interfaces. The memory 820 may include a computer program product 825, which has one or more program modules configured to perform various methods or acts of the various embodiments in the disclosure.

The communication unit 840 enables communication with other electronic devices through a communication medium. In addition, the functions of the components of the electronic device 800 may be implemented by a single computing cluster or a plurality of computing machines, which may communicate through communication connections. Therefore, the electronic device 800 may operate in a networked environment using a logical connection with one or more other servers, a network personal computer (PC), or another network node.

The input device 850 may be one or more input devices, such as a mouse, a keyboard, a tracking ball, etc. The output device 860 may be one or more output devices, such as a display, a speaker, a printer, etc. The electronic device 800 may further communicate, as needed, with one or more external devices (not shown) through the communication unit 840, the external devices such as a storage device, a display device, etc., with one or more devices that enable the user to interact with the electronic device 800, or with any devices (such as a network card, a modem, etc.) that enable the electronic device 800 to communicate with one or more other electronic devices. Such communication may be performed via input/output (I/O) interfaces (not shown).

According to an example embodiment in the disclosure, there is provided a computer-readable storage medium having computer executable instructions stored thereon, where the computer executable instructions are executed by a processor to implement the method described above. According to an example embodiment in the disclosure, there is further provided a computer program product tangibly stored on a non-transitory computer-readable medium and including computer executable instructions, where the computer executable instructions are executed by a processor to implement the method described above.

Various aspects in the disclosure are described herein with reference to the flowcharts and/or block diagrams of the method, the apparatus, the device, and the computer program product implemented according to the disclosure. It would be appreciated that each block of the flowcharts and/or block diagrams, and combinations of the blocks in the flowcharts and/or block diagrams, may be implemented by computer-readable program instructions.

These computer-readable program instructions may be provided to the processor of a general-purpose computer, a special-purpose computer, or other programmable data processing apparatus to produce a machine, so that when these instructions are executed by the processor of the computer or other programmable data processing apparatus, an apparatus that implements the functions/actions specified in one or more blocks of the flowcharts and/or block diagrams is produced. These computer-readable program instructions may also be stored in a computer-readable storage medium, and these instructions cause the computer, the programmable data processing apparatus, and/or other devices to operate in a specific manner, so that the computer-readable medium storing the instructions includes a manufactured product, which includes instructions for implementing various aspects of the functions/actions specified in one or more blocks of the flowcharts and/or block diagrams.

The computer-readable program instructions may be loaded onto a computer, another programmable data processing apparatus, or another device, so that a series of operations and steps are performed on the computer, the another programmable data processing apparatus, or the another device, to produce a computer-implemented process, so that the instructions executed on the computer, the another programmable data processing apparatus, or the another device implement the functions/actions specified in one or more blocks of the flowcharts and/or block diagrams.

The flowcharts and block diagrams in the drawings show the possibly implemented architectures, functions, and operations of the system, the method, and the computer program product according to a plurality of embodiments in the disclosure. In this regard, each block in the flowchart or block diagram may represent a module, a program segment, or a part of instructions, and the module, the program segment, or the part of instructions contains one or more executable instructions for implementing the specified logical functions. In some updated embodiments, the functions marked in the blocks may also occur in an order different from that marked in the drawings. For example, two consecutive blocks may actually be performed substantially in parallel, or they may sometimes be performed in the reverse order, depending on the functions involved. It also needs to be noted that each block in the block diagrams and/or flowcharts, and the combinations of the blocks in the block diagrams and/or flowcharts may be implemented by a special-purpose hardware-based system that executes specified functions or actions, or may be implemented by a combination of special-purpose hardware and computer instructions.

The embodiments in the disclosure have been described above, and the above description is exemplary, non-exhaustive, and not limited to the disclosed embodiments. Many modifications and variations will be apparent to those of ordinary skill in the art without departing from the scope and spirit of the described embodiments. The terms used herein are chosen to best explain the principles of the embodiments, the practical applications, or the improvements to the technologies in the market, or to enable other those of ordinary skill in the art to understand the embodiments disclosed herein.

1. A method for feature determination, comprising:
determining, using a visual encoder, a visual feature representation of an image, the visual feature representation having a first dimension;
dividing the visual feature representation into a plurality of sub-feature representations by dimension;
for each of the plurality of sub-feature representations,
determining, from a codebook of a plurality of codebooks that corresponds to the sub-feature representation, a quantized feature representation that matches the sub-feature representation, each codebook comprising a plurality of quantized feature representations; and
determining a quantized visual feature representation of the image by concatenating a plurality of quantized feature representations respectively corresponding to the plurality of sub-feature representations, the quantized visual feature representation having the first dimension.

2. The method of claim 1, further comprising:
generating, using a visual decoder, a target image based on the quantized visual feature representation.

3. The method of claim 2, wherein the visual encoder, the visual decoder, and the plurality of codebooks are trained by:
determining, using the visual encoder being trained, a sample visual feature representation of a sample image;
determining a sample quantized visual feature representation corresponding to the sample visual feature representation based on the plurality of codebooks being trained;
determining, using a text encoder, a first text feature representation of a positive sample text and a second text feature representation of a negative sample text, respectively, wherein the positive sample text matches the sample image, and the negative sample text does not match the sample image;
determining a contrastive loss based on a difference between the sample quantized visual feature representation and the first text feature representation and a difference between the sample quantized visual feature representation and the second text feature representation; and
updating the visual encoder, the visual decoder, and the plurality of codebooks based on a first training objective configured to reduce or minimize the contrastive loss.

4. The method of claim 3, wherein updating the visual encoder, the visual decoder, and the plurality of codebooks further comprises:
generating, using the visual decoder, a reconstructed image corresponding to the sample image based on the sample quantized visual feature representation;
determining a reconstruction loss based on a difference between the sample image and the reconstructed image; and
updating the visual encoder, the visual decoder, and the plurality of codebooks further based on a second training objective configured to reduce or minimize a combination of the contrastive loss and the reconstruction loss.

5. The method of claim 3, wherein the text encoder is jointly updated based on the first training objective or the second training objective.

6. The method of claim 1, wherein dividing the visual feature representation into the plurality of sub-feature representations by dimension comprises:
dividing the visual feature representation evenly by dimension to obtain the plurality of sub-feature representations.

7. The method of claim 1, wherein each of the plurality of codebooks corresponds to a respective dimension interval divided from the first dimension, and wherein determining the quantized feature representation that matches the sub-feature representation comprises:
determining, based on a dimension interval of the sub-feature representation, the codebook corresponding to the sub-feature representation; and
determining, from the corresponding codebook, the quantized feature representation that matches the sub-feature representation.

8. The method of claim 7, wherein determining the quantized visual feature representation comprises:
concatenating the plurality of quantized feature representations based on the corresponding dimension intervals to obtain the quantized visual feature representation.

9. The method of claim 1, wherein determining the visual feature representation comprises:
extracting, using the visual encoder, an intermediate visual feature representation of the image, wherein a dimension corresponding to the intermediate visual feature representation is a second dimension, and the second dimension is greater than the first dimension; and
performing, using a first multihead attention module, a dimensionality reduction operation on the intermediate visual feature representation to obtain the visual feature representation having the first dimension.

10. The method of claim 9, further comprising:
obtaining an intermediate quantized feature representation for image generation, the intermediate quantized feature representation having the first dimension;
performing, using a second multihead attention module, a dimensionality expansion operation on the intermediate quantized feature representation to obtain a target quantized feature representation, a dimension corresponding to the target quantized feature representation being the second dimension; and
generating, using the visual decoder, a target image based on the target quantized feature representation.

11. The method of claim 9, wherein performing the dimensionality reduction operation on the intermediate visual feature representation to obtain the visual feature representation comprises:
compressing, using a first linear layer and an average pooling layer in the first multihead attention module, the dimension of the intermediate visual feature representation from the second dimension to the first dimension to obtain the visual feature representation.

12. The method of claim 10, wherein performing the dimensionality expansion operation on the intermediate quantized feature representation to obtain the target quantized feature representation comprises:
expanding, using a second linear layer and a third linear layer in the second multihead attention module, the dimension of the intermediate quantized feature representation from the first dimension to the second dimension to obtain the target quantized feature representation.

13. An electronic device, comprising:
at least one processor; and
at least one memory, the at least one memory is coupled to the at least one processor and stores instructions executable by the at least one processor, the instructions, when executed by the at least one processor, causes the device to perform operations comprising:
determining, using a visual encoder, a visual feature representation of an image, the visual feature representation having a first dimension;
dividing the visual feature representation into a plurality of sub-feature representations by dimension;
for each of the plurality of sub-feature representations,
determining, from a codebook of a plurality of codebooks that corresponds to the sub-feature representation, a quantized feature representation that matches the sub-feature representation, each codebook comprising a plurality of quantized feature representations; and
determining a quantized visual feature representation of the image by concatenating a plurality of quantized feature representations respectively corresponding to the plurality of sub-feature representations, the quantized visual feature representation having the first dimension.

14. The electronic device of claim 13, wherein the operations further comprise:
generating, using a visual decoder, a target image based on the quantized visual feature representation.

15. The electronic device of claim 14, determining, using the visual encoder being trained, a sample visual feature representation of a sample image;
determining a sample quantized visual feature representation corresponding to the sample visual feature representation based on the plurality of codebooks being trained;
determining, using a text encoder, a first text feature representation of a positive sample text and a second text feature representation of a negative sample text, respectively, wherein the positive sample text matches the sample image, and the negative sample text does not match the sample image;
determining a contrastive loss based on a difference between the sample quantized visual feature representation and the first text feature representation and a difference between the sample quantized visual feature representation and the second text feature representation; and
updating the visual encoder, the visual decoder, and the plurality of codebooks based on a first training objective configured to reduce or minimize the contrastive loss.

16. The electronic device of claim 15, wherein updating the visual encoder, the visual decoder, and the plurality of codebooks further comprises:
generating, using the visual decoder, a reconstructed image corresponding to the sample image based on the sample quantized visual feature representation;
determining a reconstruction loss based on a difference between the sample image and the reconstructed image; and
updating the visual encoder, the visual decoder, and the plurality of codebooks further based on a second training objective configured to reduce or minimize a combination of the contrastive loss and the reconstruction loss.

17. The electronic device of claim 15, wherein the text encoder is jointly updated based on the first training objective or the second training objective.

18. The electronic device of claim 13, wherein dividing the visual feature representation into the plurality of sub-feature representations by dimension comprises:
dividing the visual feature representation evenly by dimension to obtain the plurality of sub-feature representations.

19. The electronic device of claim 13, wherein each of the plurality of codebooks corresponds to a respective dimension interval divided from the first dimension, and wherein determining the quantized feature representation that matches the sub-feature representation comprises:
determining, based on a dimension interval of the sub-feature representation, the codebook corresponding to the sub-feature representation; and
determining, from the corresponding codebook, the quantized feature representation that matches the sub-feature representation.

20. A non-transitory computer-readable storage medium having a computer program stored thereon, the computer program, when executed by a processor, performs operations comprising:
determining, using a visual encoder, a visual feature representation of an image, the visual feature representation having a first dimension;
dividing the visual feature representation into a plurality of sub-feature representations by dimension;
for each of the plurality of sub-feature representations,
determining, from a codebook of a plurality of codebooks that corresponds to the sub-feature representation, a quantized feature representation that matches the sub-feature representation, each codebook comprising a plurality of quantized feature representations; and
determining a quantized visual feature representation of the image by concatenating a plurality of quantized feature representations respectively corresponding to the plurality of sub-feature representations, the quantized visual feature representation having the first dimension.
